(19) United States
(12) Patent Application Publication
(10) Pub. No.: US 2011/0177187 A1
(43) Pub. Date: Jul. 21, 2011

(54) INJECTION MOLDING MACHINE PROVIDED WITH POWER TRANSMISSION MECHANISM

(75) Inventors: Koichi NISHIMURA, Minamitsuru-gun (JP); Masatoshi SENGA, Minamitsuru-gun (JP)

(73) Assignee: FANUC CORPORATION, Yamanashi (JP)

(21) Appl. No.: 12/947,225

(22) Filed: Nov. 16, 2010

(30) Foreign Application Priority Data
Jan. 19, 2010 (JP) 2010-009399

(51) Int. Cl. B29C 45/76

(52) U.S. Cl. 425/169

(57) ABSTRACT

An injection molding machine is provided with a power transmission mechanism including a plurality of drive units configured to convert a rotary motion into a linear motion and a motor configured to drive the drive units. Strain sensors are affixed individually to respective supporting members for the drive units. An abnormality signal indicative of the occurrence of an abnormality in the power transmission mechanism is output if the absolute value of the difference between a strain value read by one of the strain sensors and a strain value read by another strain sensor is greater than a previously set value.

### BACKGROUND OF THE INVENTION

1. Field of the Invention

The present invention relates to an injection molding machine with abnormality detection means for a power transmission mechanism, and more particularly, to an injection molding machine with abnormality detection means for a power transmission mechanism, which includes a plurality of drive units driven by a drive source, such as a motor, and configured to convert a rotary motion into a linear motion, the abnormality detection means being configured to detect an abnormality in the power transmission mechanism by means of strain sensors.

2. Description of the Related Art

Some injection molding machines that use a drive source, such as a motor, to perform injection molding comprise a power transmission mechanism that includes a plurality of drive units, such as ball screws, configured to convert a rotary motion of the motor into a linear motion. The power transmission mechanism used is a drive mechanism in which a driving pulley connected to the shaft of a single motor and driven pulleys coupled individually to a plurality of ball screws supported in parallel relation are connected by a transmission belt. If any one of the driven pulleys is subjected to an abnormality in the transmission belt, differences are produced between loads that act on the ball screws, individually. There is a problem that those ball screws which are heavily loaded are reduced in life.

A technique to solve the above problem is disclosed in, for example, Japanese Patent Application Laid-Open No. 4-19118. According to this technique, a current that flows through a motor is monitored, and an alarm is output if the value of the current flowing through the motor exceeds the range of monitoring reference values. In the case where this technique is applied to a power transmission mechanism in which a plurality of ball screws are driven by a single motor, however, an abnormality cannot be detected by the value of the current flowing through the motor unless the sum of loads acting individually on the ball screws changes even if differences are produced between the loads.

Another technique is disclosed in Japanese Patent Application Laid-Open No. 6-114900, in which a knockout bar is provided with an annular groove and loads are measured by strain gauges affixed to the groove. This technique is advantageous in not requiring any space for a load cell that is used to detect a compressive force. According to this technique, however, the strain gauges for the measurement are affixed to the annular groove around the proximal portion of an ejector pin, so that it cannot measure variations in loads acting on a plurality of drive units that constitute a power transmission mechanism.

### SUMMARY OF THE INVENTION

Accordingly, in consideration of the above-described problems of the prior art techniques, the object of the present invention is to provide an injection molding machine with abnormality detection means for a power transmission mechanism, capable of detecting, by means of strain sensors, an abnormality in the power transmission mechanism including a plurality of drive units, which are driven by a drive source, such as a motor, and serve to convert a rotary motion into a linear motion.

An injection molding machine according to the present invention is provided with a power transmission mechanism including a plurality of drive units configured to convert a rotary motion into a linear motion, a motor configured to drive the drive units, strain sensors mounted individually on respective supporting members for the drive units, means for reading strain values synchronously detected by the strain sensors, means for determining whether or not an absolute value of a difference between a strain value read by one strain sensor and a strain value read by another strain sensor, out of the strain values from the strain sensors read by the strain value reading means, is greater than a previously set value, and abnormality signal output means which outputs an abnormality signal indicative of the occurrence of an abnormality in the power transmission mechanism if it is determined by the determining means that the absolute value of the difference between the strain values is greater than the previously set value.

The power transmission mechanism may be an ejector mechanism. In this case, the drive units of the power transmission mechanism may include a plurality of ball screws and nuts in engagement with the screws, and the supporting members on which the strain sensors are mounted may be bearing housings by which the ball screws are rotatably mounted on a movable platen of the injection molding machine.

In the injection molding machine provided with the power transmission mechanism including the drive units that are driven by the motor or some other drive source and serve to convert a rotary motion into a linear motion, according to the present invention, an abnormality in the power transmission mechanism can be detected by means of the strain sensors.

### BRIEF DESCRIPTION OF THE DRAWINGS

The above and other objects and features of the present invention will be obvious from the ensuing description of embodiments with reference to the accompanying drawings, in which:

FIG. 1 is a view showing a principal part of one embodiment of an injection molding machine with abnormality detection means for a power transmission mechanism according to the present invention;

FIG. 2 is a view illustrating a force that acts when a molded product is ejected as the parallelism between a knockout bar and a mold mounting surface is broken in the injection molding machine of FIG. 1; and

FIG. 3 is a flowchart showing an algorithm of abnormality detection processing for the power transmission mechanism executed for each predetermined period by a controller of the injection molding machine of FIG. 1.

### DETAILED DESCRIPTION OF THE PREFERRED EMBODIMENTS

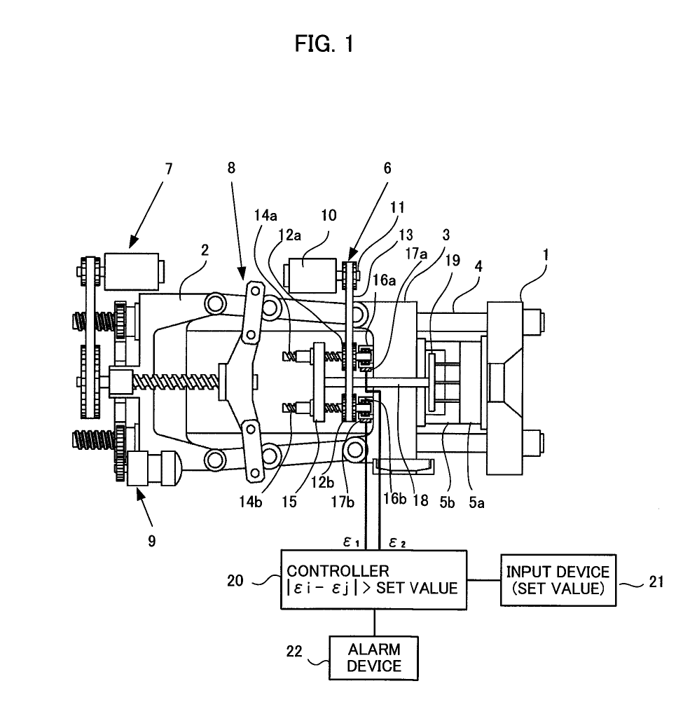

FIG. 1 is a view showing a principal part of one embodiment of an injection molding machine with abnormality detection means for a power transmission mechanism according to the present invention.

The injection molding machine comprises an injection unit for injecting resin into a mold, a mold clamping unit for clamping the mold, and a controller for generally controlling the injection molding machine. The controller, like conventional controllers, comprises a processor, memory, display device, and signal input device.

FIG. 1 mainly shows the mold clamping unit of the injection molding machine. A stationary platen 1 and a rear platen 2 are connected to each other by a plurality of tie-bars 4. A movable platen 3 is located between the stationary and rear platens 1 and 2 so as to be movable along the tie-bars 4. A stationary mold 5a and a movable mold 5b are mounted on the stationary platen 1 and the movable platen 3, respectively. The rear platen 2 is furnished with a mold opening/closing mechanism 7, which drives the movable platen 3 by means of a toggle mechanism 8, thereby opening, closing, or clamping the stationary and movable molds 5a and 5b.

In the present embodiment of the invention, the power transmission mechanism attached to the injection molding machine is an ejector mechanism comprising a plurality of drive units, such as ball screws.

The respective shafts of two ball screws 14a and 14b are rotatably mounted on the movable platen 3 by bearing housings 16a and 16b. In this arrangement, the bearing housings 16a and 16b constitute supporting members for the drive units. Driven pulleys 12a and 12b are mounted on the two ball screws 14a and 14b, respectively. On the other hand, a driving pulley 11 is connected to a servomotor 10 for ejector. A toothed belt 13 is passed around and between the driving pulley 11 and the driven pulleys 12a and 12b.

Nuts that are engaged with the ball screws 14a and 14b are individually connected to a plate called a knockout bar 15. A plurality of ejector pins 18 are mounted on the knockout bar 15.

The rotation of the servomotor 10 for ejector is transmitted to the driven pulleys 12a and 12b through the driving pulley 11 and the toothed belt 13. As the driven pulleys 12a and 12b rotate, the ball screws 14a and 14b rotate, whereupon the knockout bar 15 connected to the nuts axially advances or retreats. Consequently, the ejector pins 18 mounted on the knockout bar 15 axially advance or retreat so that an ejector plate 19 in the movable mold 5b advances or retreats, whereupon pins on the ejector plate 19 eject a molded product.

As the pins on the ejector plate 19 eject the molded product, the ejector pins 18 receive a reaction force from the molded product. The reaction force (load) received by the ejector pins 18 is transmitted to the bearing housings 16a and 16b through the knockout bar 15 and the ball screws 14ad and 14b. As this is done, the bearing housings 16a and 16b undergo a strain proportional to the load received thereby.

In assembling the power transmission mechanism, the knockout bar 15 and a mold mounting surface of the movable platen 3 are adjusted to be parallel to each other so that the two ball screws 14a and 14b are equally loaded. Therefore, the two bearing housings 16a and 16b are equally strained. If either of the ball screws 14a and 14b is subjected to an abnormality such as jumping, the parallelism between the knockout bar 15 and the mold mounting surface of the movable platen 3 is inevitably broken.

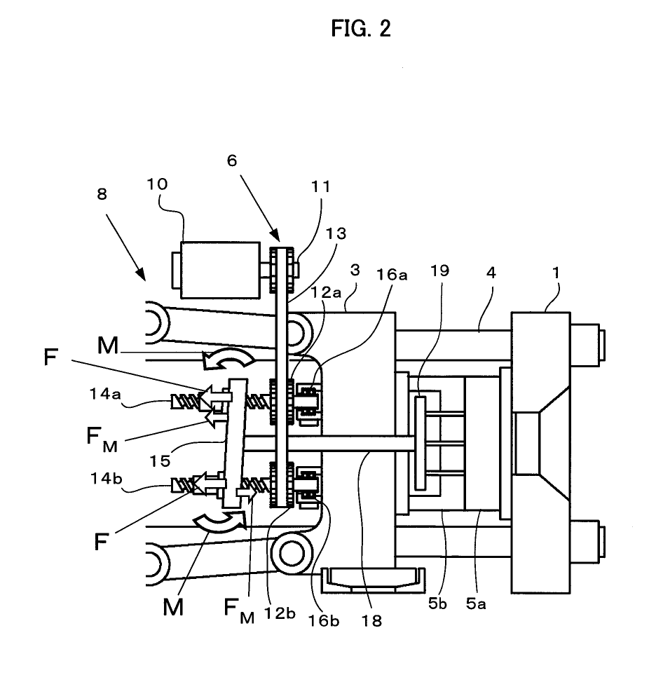

Thereupon, a reaction force F_{M} based on a moment M that urges the inclined knockout bar 15 to restore its parallelism is added to a reaction force F produced when the molded product is ejected, as shown in FIG. 2, so that the ball screws 14a and 14b cease to be equally loaded. Consequently, the bearing housings 16a and 16b also cease to be equally strained.

The bearing housings 16a and 16b are provided with strain sensors 17a and 17b. Strains of the bearing housings 16a and 16b detected by the strain sensors 17a and 17b are converted into electrical signals, which are transmitted to a controller 20. The strain sensors 17a and 17b may be replaced with, for example, strain gauges affixed directly to the bearing housings 16.

The controller 20 reads detected values of the strains transmitted from the strain sensors 17a and 17b and obtains the absolute value of the difference between the two read detected strain values. It is determined whether or not the obtained absolute value of the difference between the detected values is greater than a value previously set by an input device 21. If it is determined that the absolute value of the difference between the detected values is higher than the set value, an abnormality detection signal is originated. The abnormality signal originated by the controller 20 is output to an alarm device 22, such as an alarm lamp, and turns on the lamp, thereby informing an operator of the occurrence of an abnormality. Alternatively, the abnormality signal is received in the controller 20 and used for processing for forced shutdown of the machine controlled by the controller 20.

The above is a description of abnormality detection for the ball screws 14a and 14b of the ejector mechanism as an example of the power transmission mechanism attached to the injection molding machine. However, the invention is also applicable to ball screws of a mold clamping shaft or injection shaft as the power transmission mechanism.

While the motor and the ball screws are connected by the pulleys and the belt in the present embodiment of the invention, moreover, the invention is also applicable to connection by a chain and sprockets or by gears. Further, the invention is applicable to the case where three or more ball screws are used.

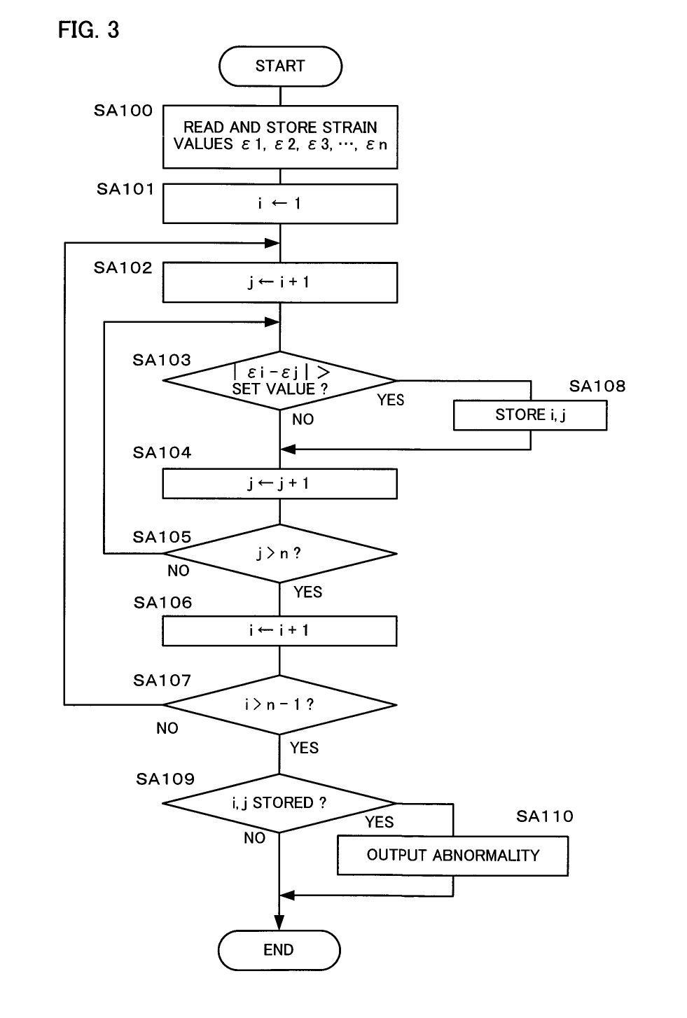

FIG. 3 is a flowchart showing an algorithm of abnormality detection processing for the power transmission mechanism executed for each predetermined period by the controller of the injection molding machine shown in FIG. 1. The power transmission mechanism as an object of the abnormality detection processing comprises n (n: integer number of 2 or more) number of drive units, such as ball screws, for converting a rotary motion into a linear motion. These drive units are each provided with a strain sensor. This abnormality detection processing is performed for each predetermined period during ejector operation of the injection molding machine. The following is a description of steps of this processing.

[Step SA100] Detected strain values ε1, ε2, ε3, . . . , εn from the strain sensors located individually in drive units 1, 2, 3, . . . , n are read and stored.

[Step SA101] An index i is set to 1.

[Step SA102] An index j is set to i+1.

[Step SA103] It is determined whether or not the absolute value, |εi−εj|, of the difference between a detected value εi from the strain sensor in a drive unit i and a detected value εj from the strain sensor in a drive unit j is greater than the set value. If the value |εi−εj| is greater than the set value, the program proceeds to Step SA108. If not, the program proceeds to Step SA104.

[Step SA104] The value of the index j is set by adding 1 to the value of the preceding index j.

[Step SA105] It is determined whether or not the value of the index j is greater than the total number, n, of drive units (i.e., the total number of strain sensors). If the value of the index j is greater than n, the program proceeds to Step SA106. If not, the program returns to Step SA103.

[Step SA106] The value of the index i is set by adding 1 to the value of the preceding index i.

[Step SA107] It is determined whether or not the value of the index i is greater than n−1. If the value of the index i is greater than n−1, the program proceeds to Step SA109. If not, the program returns to Step SA102.

[Step SA108] If it is determined in Step SA103 that the value |εi−εj| is greater than the set value, then it means that there is a difference in load between the drive units i and j. In this case, the combination, (i, j), of the drive units i and j is stored in the memory, whereupon the program proceeds to Step SA104.

[Step SA109] It is determined whether or not there is the combination (i, j) of the drive units i and j stored in Step SA108. If there is the combination, the program proceeds to Step SA110, in which an abnormality output indicative of the occurrence of an abnormality in the combination of the drive units i and j is delivered, whereupon the processing terminates.

In the processing shown in the flowchart described above, an abnormal combination of drive units, out of the n number of drive units that constitute the power transmission mechanism, is identified in Step SA103, and the result of the identification, (i, j), is stored in Step SA108.

If only the occurrence of an abnormality in the power transmission mechanism of the injection molding machine is expected to be detected, the abnormality output may be delivered without storing the combination (i, j) of the identified drive units i and j. Further, the abnormality output may be delivered if the difference between maximum and minimum values detected for the n number of drive units is greater than a set value.

1. An injection molding machine provided with a power transmission mechanism comprising a plurality of drive units configured to convert a rotary motion into a linear motion and a motor configured to drive the drive units, the injection molding machine comprising:
strain sensors mounted individually on respective supporting members for the drive units;
means for reading strain values synchronously detected by the strain sensors;
means for determining whether or not an absolute value of a difference between a strain value read by one strain sensor and a strain value read by another strain sensor, out of the strain values from the strain sensors read by the strain value reading means, is greater than a previously set value; and
abnormality signal output means which outputs an abnormality signal indicative of the occurrence of an abnormality in the power transmission mechanism if it is determined by the determining means that the absolute value of the difference between the strain values is greater than the previously set value.

2. The injection molding machine according to claim 1, wherein the power transmission mechanism is an ejector mechanism, the drive units of the power transmission mechanism comprise a plurality of ball screws and nuts in engagement with the screws, and the supporting members on which the strain sensors are mounted are bearing housings by which the ball screws are rotatably mounted on a movable platen of the injection molding machine.
